(19) United States
(12) Patent Application Publication
(10) Pub. No.: US 2026/0326887 A1
(43) Pub. Date: Oct. 22, 2026

(54) VEHICLE COMPRISING AT LEAST ONE PASSIVE VENT FOR VENTING AN ASCENDING GAS

(71) Applicant: Airbus Operations SAS, TOULOUSE (FR)

(72) Inventors: Ludovic DAVELOOSE, TOULOUSE (FR); Fabien CHAPONET, TOULOUSE (FR)

(21) Appl. No.: 19/468,063

(22) Filed: Feb. 3, 2026

(30) Foreign Application Priority Data
Feb. 12, 2025 (FR) FR2501440

(51) Int. Cl. B64C 7/02; B64D 37/30; B64D 37/32

(52) U.S. Cl. CPC B64C 7/02; B64D 37/30; B64D 37/32

(57) ABSTRACT

A vehicle having an aerodynamic wall with an aerodynamic surface against which an airflow flows from the front to the rear, an accumulation zone in which an ascending gas accumulates, and, a vent. The vent has a duct connecting the accumulation zone and the aerodynamic surface, a deflector connected to the aerodynamic wall, positioned above the duct and configured to deflect, towards the rear, a gas flow exiting the duct.

### CROSS-REFERENCES TO RELATED APPLICATIONS

This application claims the benefit of French Patent Application Number FR2501440 filed on Feb. 12, 2025, the entire disclosure of which is incorporated herein by way of reference.

### FIELD OF THE INVENTION

The present application relates to a vehicle comprising at least one passive vent for venting an ascending gas such as hydrogen.

### BACKGROUND OF THE INVENTION

According to one known embodiment, a hydrogen-powered aircraft comprises at least one hydrogen tank and hydrogen pipes connecting the hydrogen tank and hydrogen turbojets or fuel cells powering electric motors. All of this equipment is designed to limit the risk of hydrogen leaks. However, the risk of leaks cannot be entirely eliminated and hydrogen can accumulate in a zone of the aircraft.

### SUMMARY OF THE INVENTION

The present invention aims to enhance the safety of any vehicle powered by hydrogen (or any other ascending gas) by limiting the risk of such a gas accumulating in the vehicle.

To this end, the invention relates to a vehicle comprising at least one aerodynamic wall that has an aerodynamic surface, against which an airflow can flow in a direction of flow from the front to the rear, and at least one accumulation zone in which an ascending gas can accumulate.

According to the invention, the vehicle comprises at least one vent comprising:
a. at least one duct that extends between a first end emerging in the accumulation zone and a second end emerging on the aerodynamic surface,
b. at least one deflector positioned above the duct and configured to deflect, towards the rear, a gas flow exiting the duct through its second end,
c. and at least one connecting system connecting the deflector and the aerodynamic wall.

This solution makes it possible to avoid the accumulation of a gas, such as hydrogen for example, in a vehicle, by channeling it to the outside of said vehicle.

According to another feature, the upper part of the accumulation zone is delimited by the aerodynamic wall, the duct being a hole that passes through the aerodynamic wall.

According to another feature, the deflector is symmetrical with respect to a plane of symmetry parallel to the direction of flow.

According to another feature, the deflector comprises at least one plate and at least one deflection wall connected to the plate and forming a single part therewith.

According to another feature, the deflection wall comprises at least one trailing edge that has a rear section spaced apart from the plate and offset towards the rear with respect to the second end of the duct.

According to another feature, the trailing edge is symmetrical with respect to the plane of symmetry.

According to another feature, the trailing edge is offset towards the rear with respect to the second end of the duct so that a first straight line passing through said section and a rear point of the second end forms an angle of between 15 and 45° with a second straight line passing through the rear point and perpendicular to the aerodynamic surface.

According to another feature, the rear section of the trailing edge comprises a drip groove.

According to another feature, the vent comprises a sealing system interposed between the deflector and the aerodynamic wall and positioned around the second end of the duct.

According to another feature, the sealing system comprises a film and/or an O-ring interposed between the deflector and the aerodynamic wall, around the second end of the duct.

According to another feature, the deflector is configured to limit the aerodynamic interference on the airflow.

### BRIEF DESCRIPTION OF THE DRAWINGS

Further features and advantages will become apparent on reading the following description of the invention, which is given by way of example only, with reference to the appended drawings, in which:

FIG. 1 is a side view of an aircraft,

FIG. 2 is a schematic longitudinal cross-section of part of an aerodynamic wall equipped with a passive vent illustrating one embodiment of the invention,

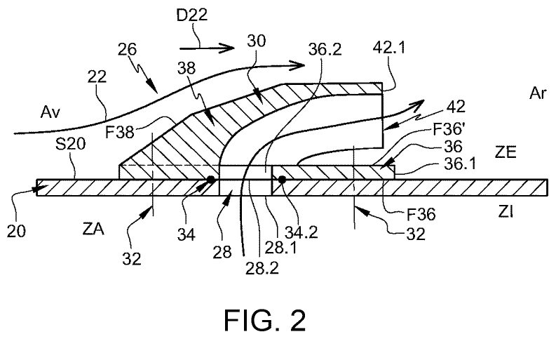

FIG. 3 is a longitudinal cross-section of part of an aerodynamic wall equipped with a passive vent illustrating another embodiment of the invention,

FIG. 4 is a perspective view of a deflector of the vent shown in FIG. 3,

FIG. 5 is a top view of the deflector shown in FIG. 4.

### DETAILED DESCRIPTION OF THE PREFERRED EMBODIMENTS

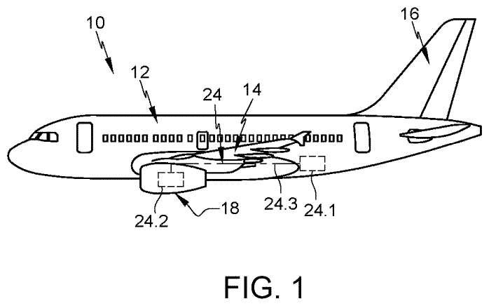

According to an embodiment shown in FIG. 1, an aircraft 10 comprises a fuselage 12, wings 14 situated on either side of the fuselage 12, a tail unit 16 situated at the rear of the fuselage 12, and propulsion units 18 positioned under the wings 14 and connected thereto. All of these elements comprise at least one aerodynamic wall 20 that has an aerodynamic surface S20 against which an airflow 22 flows in a direction of flow D22 from the front Av to the rear Ar.

The aerodynamic wall 20 separates an outer zone ZE in contact with the aerodynamic surface S20 and an inner zone ZI.

For the remainder of the description, a longitudinal direction is parallel to the direction of flow D22. A longitudinal plane is parallel to the direction of flow D22 and to a normal direction perpendicular to the aerodynamic surface S20.

According to one configuration, the aircraft 10 comprises at least one hydrogen circuit 24 that comprises at least one hydrogen tank 24.1, at least one item of hydrogen-powered equipment 24.2, such as a turbojet or fuel cell for example, and at least one hydrogen pipe 24.3 connecting the hydrogen tank 24.1 and the hydrogen-powered equipment 24.2.

In the event of a leak, hydrogen can accumulate in an accumulation zone ZA situated, for example, under the aerodynamic wall 20.

Of course, the invention is not limited to this application. The invention can thus be applied to any vehicle comprising:
a. at least one aerodynamic wall 20 that has an aerodynamic surface S20, in contact with an outer zone ZE, against which an airflow 22 can flow in a direction of flow D22 from the front to the rear,
b. at least one accumulation zone ZA in which an ascending gas can accumulate.

The upper part of the accumulation zone ZA is delimited by an upper wall 25, which can be the aerodynamic wall 20 or a different wall from the aerodynamic wall 20. When the upper wall 25 and the aerodynamic wall 20 form a single wall, the accumulation zone ZA is included in the inner zone ZI.

The upper wall 25 is configured to allow the accumulation of the ascending gas. It can be exclusively intended for this accumulation function or have other functions such as forming a barrier between inner and outer zones ZE, ZI as an aerodynamic wall.

According to one application, the ascending gas is hydrogen. However, other gases can be envisaged provided that they are lighter than air.

The aircraft 10 comprises at least one passive vent 26, configured to vent the ascending gas to the outer zone ZE, comprising:
a. at least one duct 28 that extends between a first end 28.1 emerging in the accumulation zone ZA and a second end 28.2 emerging on the aerodynamic surface S20 in the outer zone ZE,
b. at least one deflector 30 positioned above the duct 28 and configured to deflect, in the longitudinal direction and towards the rear, a flow of gas exiting the duct 28 through the second end 28.2,
c. and at least one connecting system 32 connecting the deflector 30 and the aerodynamic wall 20.

According to one embodiment, when the upper wall 25 and the aerodynamic wall 20 form a single wall, the duct 28 is a cylindrical hole passing through the aerodynamic wall 20.

According to one configuration, the connecting system 32 comprises fastening elements 32.1 such as bolts or rivets, for example. According to one arrangement, the connecting system comprises four fastening elements 32.1 and each fastening element 32.1 comprises a countersunk head flush with the surface of the deflector 30.

As a variant or in addition, the connecting system 32 comprises a film of adhesive interposed between the deflector 30 and the aerodynamic wall 20.

Of course, the invention is not limited to these solutions for the connecting system 32.

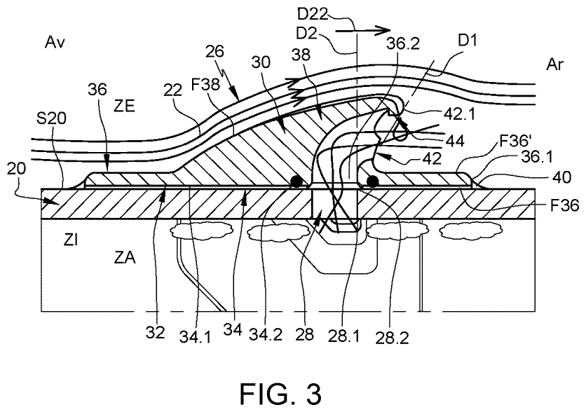

According to an embodiment shown in FIG. 3, the vent 26 comprises a sealing system 34 interposed between the deflector 30 and the aerodynamic wall 20 and positioned around the second end 28.2 of the duct 28. According to one configuration, the sealing system 34 comprises a film 34.1, made from polytetrafluoroethylene or polyurethane gel, interposed between the deflector 30 and the aerodynamic wall 20, around the second end 28.2 of the duct 28.

As a variant or in addition, the sealing system 34 comprises an O-ring 34.2 interposed between the deflector 30 and the aerodynamic wall 20, around the second end 28.2 of the duct 28.

Of course, the invention is not limited to these solutions for the sealing system 34.

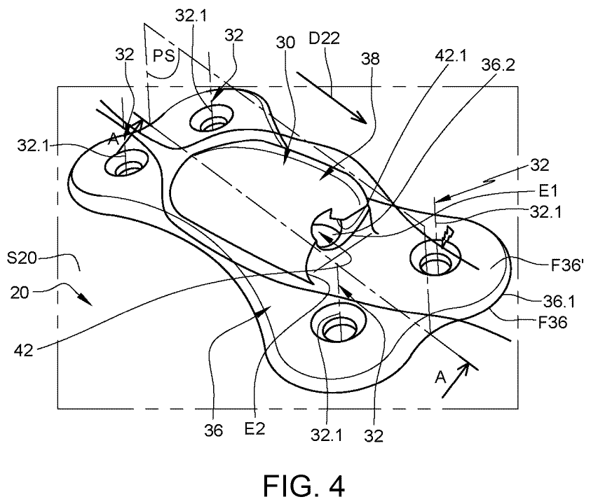

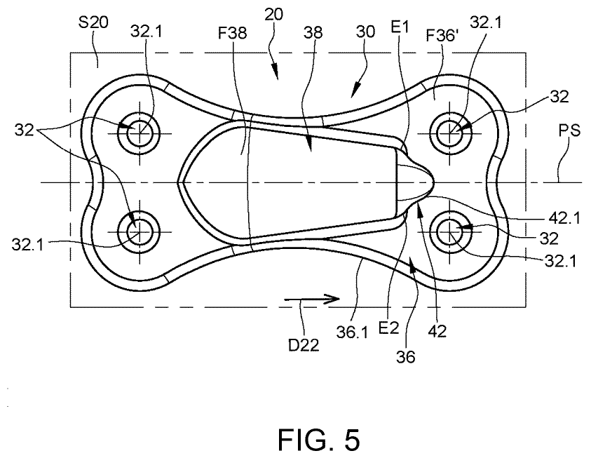

According to an embodiment shown in FIGS. 3 to 5, the deflector 30 is symmetrical with respect to a plane of symmetry PS parallel to the longitudinal direction or direction of flow D22, preferably passing through the axis of the second end 28.2 of the duct 28.

The deflector 30 can be made from a composite material using a three-dimensional printing process. Of course, the invention is not limited to this method or this material.

According to one configuration, the deflector 30 comprises at least one plate 36 and at least one deflection wall 38 connected to the plate 36 and forming a single part therewith.

According to one arrangement, the plate 36 has a lower face F36 oriented towards the aerodynamic wall 20, an upper face F36′ opposite the lower face F36, on which the deflection wall 38 is situated, and a peripheral edge 36.1 connecting the lower and upper faces F36, F36′. The plate 36 comprises an orifice 36.2 connecting the lower and upper faces F36, F36′ and extending the duct 28.

According to one arrangement, the plate 36 is substantially planar. According to this arrangement, if the aerodynamic wall 20 is not planar, the vent 26 comprises at least one interface provided between the plate 36 of the deflector 30 and the aerodynamic wall 20 in order to fill the space between the plate 36 and the aerodynamic wall 20.

According to another arrangement, when the aerodynamic wall 20 is curved, the plate 36 is shaped like the aerodynamic wall 20 so that the lower face F36 of the plate 36 follows the curvature of the aerodynamic surface S20.

The connecting system 32 is configured to connect the plate 36 of the deflector 30 and the aerodynamic wall 20.

The deflector 30 is configured to limit the aerodynamic interference on the airflow 22. The peripheral edge 36.1 is thus as small as possible in order to reduce the aerodynamic interference generated by the plate 36 of the deflector 30.

According to an embodiment shown in FIG. 3, the vent 26 comprises a peripheral bead 40 connecting the aerodynamic wall 20 and the peripheral edge 36.1 of the plate 36, configured to reduce the aerodynamic interference generated by the plate 36 of the deflector 30.

According to one arrangement, the peripheral edge 36.1 approximately describes a rectangle with rounded corners. Of course, the invention is not limited to this geometry for the plate 36.

According to a configuration shown in FIGS. 3 to 5, the deflection wall 38 comprises at least one trailing edge 42 that has a rear section 42.1 spaced apart from the plate 36 and offset towards the rear with respect to the second end 28.2 of the duct 28. According to one arrangement, the trailing edge 42 is offset towards the rear with respect to the second end 28.2 of the duct 28 so that a first straight line D1 passing through said rear section 42.1 and a rear point of the second end 28.2 (corresponding to the rearmost point of the second end 28.2) forms an angle of between 15 and 45° with a second straight line D2 passing through the rear point and perpendicular to the aerodynamic surface S20. According to one arrangement, the trailing edge 42 is symmetrical with respect to the plane of symmetry PS. The trailing edge 42 describes an ovoid shape. As a variant, the trailing edge 42 extends between first and second ends situated on the plate 36 and approximately describes an inverted U-shape.

According to one embodiment, the rear section 42.1 of the trailing edge 42 comprises a drip groove 44 to limit the risk of a liquid flowing by capillary action from the rear section 42.1 of the trailing edge 42 towards the second end 28.2 of the duct 28.

According to one configuration, the deflection wall 38 is in the shape of an umbrella and comprises an outer surface F38 configured to limit aerodynamic interference.

In addition, the vent 26 can comprise at least one connector configured to connect, when the vehicle is stationary, a duct of a ventilation system in order to ventilate the accumulation zone ZA, and/or at least one sensor configured to measure the concentration of ascending gas in the accumulation zone ZA.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A vehicle comprising:
at least one aerodynamic wall that has an aerodynamic surface against which an airflow flows in a direction of flow from a front to a rear;
at least one accumulation zone in which an ascending gas accumulates; and,
at least one vent comprising:
at least one duct extending between a first end emerging in the at least one accumulation zone and a second end emerging on the at least one aerodynamic surface,
at least one deflector positioned above the at least one duct and configured to deflect, towards the rear, a gas flow exiting the at least one duct through the second end, and,
at least one connecting system connecting the at least one deflector and the at least one aerodynamic wall.

2. The vehicle according to claim 1, wherein an upper part of the at least one accumulation zone is delimited by the at least one aerodynamic wall, and
wherein the at least one duct comprises a hole passing through the at least one aerodynamic wall.

3. The vehicle according to claim 1, wherein the at least one deflector is symmetrical with respect to a plane of symmetry parallel to the direction of flow.

4. The vehicle according to claim 1, wherein the at least one deflector comprises at least one plate and at least one deflection wall connected to the at least one plate and forming a single part therewith.

5. The vehicle according to claim 4, wherein the at least one deflection wall comprises at least one trailing edge that has a rear section spaced apart from the at least one plate and offset towards the rear with respect to the second end of the at least one duct.

6. The vehicle according to claim 5, wherein the at least one trailing edge is with respect to a plane of symmetry parallel to the direction of flow.

7. The vehicle according to claim 6, wherein the at least one trailing edge is offset towards the rear with respect to the second end of the at least one duct in such a way that a first straight line passing through the rear section and a rear point of the second end forms an angle of between 15 and 45° with a second straight line passing through the rear point and perpendicular to the aerodynamic surface.

8. The vehicle according to claim 5, wherein the rear section of the at least one trailing edge comprises a drip groove.

9. The vehicle according to claim 1, wherein the at least one vent comprises a sealing system interposed between the at least one deflector and the at least one aerodynamic wall and positioned around the second end of the at least one duct.

10. The vehicle according to claim 9, wherein the sealing system comprises a film, or an O-ring, or both interposed between the at least one deflector and the at least one aerodynamic wall, around the second end of the at least one duct.

11. The vehicle according to claim 1, wherein the at least one deflector is configured to limit aerodynamic interference on the airflow.
